(19) United States
(12) Patent Application Publication
(10) Pub. No.: US 2020/0134607 A1
(43) Pub. Date: Apr. 30, 2020

(54) METHOD AND SYSTEM FOR OWNERSHIP AND CLASSIFICATION OF DIGITAL CURRENCY

(71) Applicants: Naveen Kumar KR, Bengaluru (IN); Vignesh Viswanathan, Bengaluru (IN); Varun Warrior, Bengaluru (IN)

(72) Inventors: Naveen Kumar KR, Bengaluru (IN); Vignesh Viswanathan, Bengaluru (IN); Varun Warrior, Bengaluru (IN)

(73) Assignee: Unisys Corporation, Blue Bell, PA (US)

(21) Appl. No.: 16/223,226

(22) Filed: Dec. 18, 2018

(30) Foreign Application Priority Data
Oct. 24, 2018 (IN) 201811040118

(51) Int. Cl. G06Q 20/36

(52) U.S. Cl. CPC G06Q 20/3678; G06Q 20/363

(57) ABSTRACT

A method and system for ownership and classification of digital currency. The method includes establishing identification to a digital currency unit, establishing identification to a user, establishing ownership of the digital currency unit to the user, and assigning a first category of use to the digital currency unit owned by the user. The method also includes receiving from the user a request for a purchase associated with the first category of use from a merchant using the digital currency unit owned by the user, changing the ownership of the digital currency unit used in the purchase from the user to the merchant in response to the purchase, and changing the first category of use of the digital currency unit used in the purchase to a second category of use in response to the purchase.

### BACKGROUND

### Field

The instant disclosure relates generally to digital currency, and in particular to methods and systems for ownership and classification of digital currency.

### Description of the Related Art

Digital currency is a type of currency that is available only in digital form, and not in physical form. Digital currency exhibits properties similar to physical currencies, but digital currency allows for instantaneous transactions and borderless transfer-of-ownership. Digital currencies are intangible, and typically are owned and transacted in only by using computers or electronic wallets, which are connected to the Internet or other designated networks. In contrast, physical currencies (e.g., bank notes and minted coins) are tangible, and physical currency transactions are possible only by parties who have physical ownership of the physical currency.

Digital currency typically is a money balance recorded electronically on a stored-value card or other device. Like conventional physical currencies, digital currency can be used to purchase physical goods and pay for services. However, digital currency may be restricted for use only in certain communities, such as gaming sites or social networks.

Conventional digital currency systems do have several problems, including the phishing and spoofing of digital currency payment information. Phishing and spoofing digital currency payment information involves impersonating a business or other entity, or other use of deception, for the purposes of tricking a digital currency user into providing digital currency payment or digital currency payment information. Other problems associated with digital currency systems include the hacking of digital currency payment gateways, user address errors, the spoofing of user addresses, and the loss of digital currency wallet files.

There is a need for a method and system for ownership and classification of digital currency.

### SUMMARY

Disclosed is a method and system for ownership and classification of digital currency. The method includes establishing identification to at least one unit of digital currency within a digital currency system. The method also includes establishing identification to at least one user enrolled in the digital currency system. The method also includes establishing ownership of the at least one unit of digital currency to the at least one user. The method also includes assigning at least one first category of use to the at least one unit of digital currency owned by the at least one user. The method also includes receiving from the at least one user a request for a purchase associated with the at least one first category of use from a merchant enrolled in the digital currency system using the at least one unit of the digital currency owned by the at least one user. The method also includes, in response to the purchase, changing the ownership of the at least one unit of the digital currency used in the purchase from the at least one user to the merchant. The method also includes, in response to the purchase, changing the at least one first category of use of the at least one unit of digital currency used in the purchase to at least one second category of use. Changing the ownership of the at least one unit of the digital currency used in the purchase indicates that the at least one unit of the digital currency used in the purchase now belongs to the merchant. Changing the at least one first category of use of the at least one unit of digital currency used in the purchase to the at least one second category of use allows the merchant to use the at least one unit of the digital currency used in the purchase according to a second set of rules defining the use digital currency assigned to the at least one second category of use.

### BRIEF DESCRIPTION OF THE DRAWINGS

FIG. 1 is a schematic view of a two-party digital currency transaction, according to an embodiment;

FIG. 2 is a schematic view of the digital currency ownership and classification associated with the two-party digital currency transaction of FIG. 1, according to an embodiment;

FIG. 3 is a schematic view of conventional currency road project transaction involving a government contractor;

FIG. 4 is a schematic view of the road project transaction of FIG. 3, using ownership and classification of digital currency (OCD), according to an embodiment;

FIG. 5 is a schematic view of a unit of digital currency, including the owner and possible category of use to which the digital currency unit belongs, according to an embodiment; and

FIG. 6 is a flow diagram of a method for ownership and classification of digital currency, according to an embodiment.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting, and merely set forth some of the many possible embodiments for the claimed invention.

To address the problems associated with conventional digital currency systems and digital currency transactions, embodiments of the invention include a digital currency system that introduces ownership and classification of digital currency (OCD). According to an embodiment, ownership and classification of digital currency within the OCD digital currency system achieves complete transparency of digital currency transactions, and therefore can prevent typical fraudulent activities that occur during conventional digital currency transactions.

According to an embodiment, ownership and classification is given for every unit of digital currency issued by the OCD digital currency system. With regard to identification, a currency unique number is assigned to each denominated unit of digital currency issued by the OCD digital currency system. With regard to ownership, a user unique number is assigned to a user or party involved to identify the ownership of the particular unit of digital currency issued or sanctioned by the OCD digital currency system. With regard to classification, each denominated unit of digital currency having a currency unique number has assigned or belongs to one (or more) of a set of defined categories of use.

According to an embodiment, the administrator of the OCD digital currency system (e.g., the government, an administrative agency within the government, or some other appropriate administrative body) assigns a currency unique number to each denominated unit of digital currency issued by the OCD digital currency system. The administrator of the digital currency system assigns currency unique numbers to the digital currency units when the administrator of the digital currency system issues or releases the digital currency units into the OCD digital currency system. Once assigned, the currency unique number of each denominated unit of digital currency does not change.

Also, according to an embodiment, users of the OCD digital currency system enroll in or register with the OCD digital currency system. The administrator of the OCD digital currency system assigns a user unique number to each user when the user successfully enrolls in or registers with the OCD digital currency system.

In addition to the administrator of the OCD digital currency system assigning a currency unique number for each unit of digital currency upon release of the digital currency unit, the administrator of the digital currency system also assigns a category of use to each released digital currency unit. The administrator of the OCD digital currency system determines the categories of use and the set of rules for each category of use. Example categories of use can include General, Food, Fuel, Government Relief Funds, Agriculture, Medical, Pension, Stipend, Profits over Fixed Deposits, and other suitable categories of use.

As will be discussed in greater detail hereinbelow, each category of use has a defined set of rules for the use of digital currency units assigned to that category of use. However, the category of use to which a particular digital currency unit belongs can change as the result of a digital currency transaction involving that particular digital currency unit. For example, a General category of use allows a digital currency unit assigned to that category of use to be used in any way desired by the owner of that particular digital currency unit. However, a Medical category of use allows a digital currency unit assigned to that category of use to be used only for qualified medical purposes, e.g., as part of a qualified medical transaction involving the digital currency unit.

According to an embodiment, a digital currency unit belonging to one particular category of use has its own limitations. That is, each digital currency unit is permitted to be transactional only by following the defined set of rules for the particular category of use to which the digital currency unit belongs. After a digital currency transaction, the category of use for the digital currency unit involved in that particular digital currency transaction may or may not be changed to a different category of use, depending on the type of digital currency transaction and the particular parties involved in the digital currency transaction.

In conventional digital currency systems, digital currency units do not have assigned currency unique numbers. That is, conventional digital currency systems do not treat each denominated unit of digital currency with a unique number or any other unique form of identification. Also, conventional digital currency systems do not classify each denominated unit of digital currency within the digital currency system.

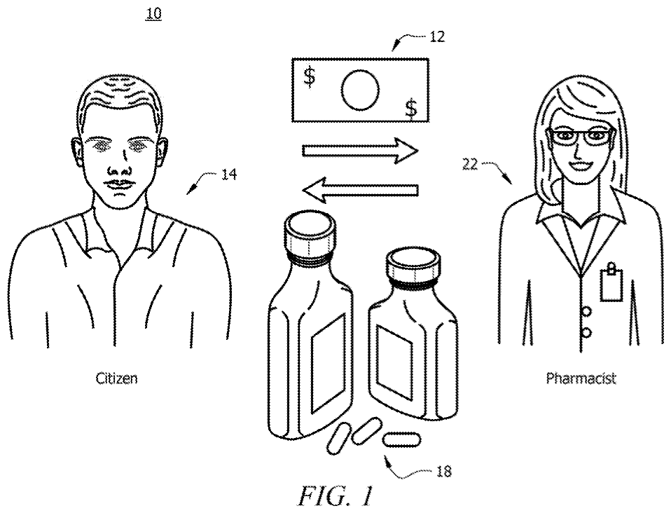

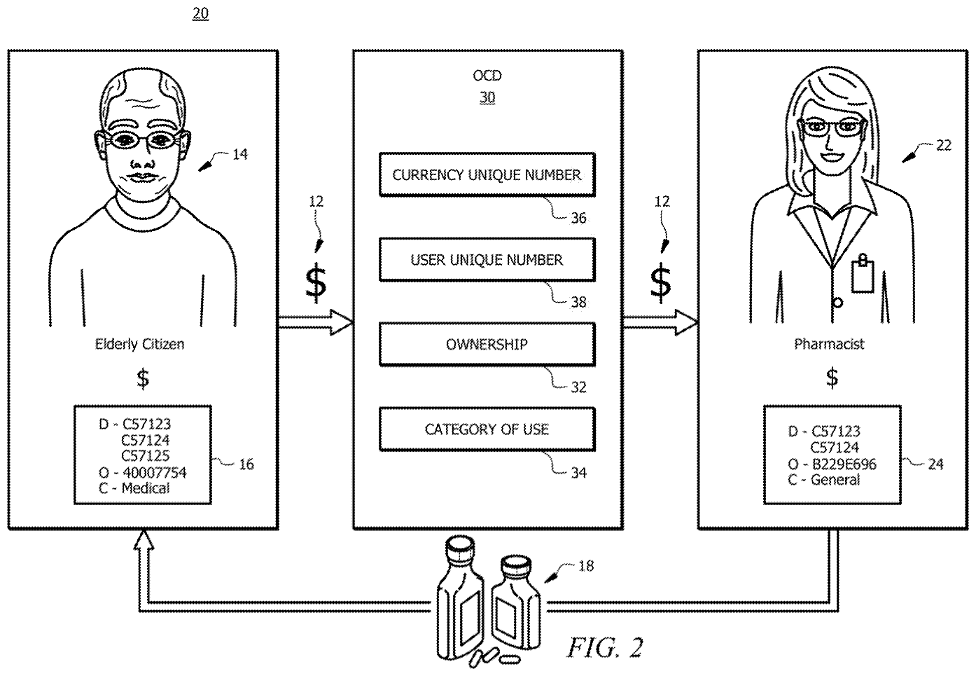

FIG. 1 is a schematic view of a two-party digital currency transaction 10, according to an embodiment. FIG. 2 is a schematic view 20 of the digital currency ownership and classification associated with the two-party digital currency transaction of FIG. 1, according to an embodiment. In this two-party digital currency transaction 10, assume that a particular amount of digital currency 12 (which can be one or more denominated units of digital currency) has been sanctioned for a citizen/user/customer 14 for medical expenses of the citizen 14. As discussed hereinabove, each denominated unit of the digital currency 12 has an assigned currency unique number (e.g., three digital currency units: C57123, C57124, C57125).

Before the transaction 10 occurs, the ownership of the digital currency 12 belongs to the citizen 14, and the digital currency 12 has a Medical category of use, which means that the digital currency 12 can be used only for medical expenses, i.e., according to a set of rules and use restrictions associated with the Medical category of use, as defined by the administrator of the OCD digital currency system. As shown in FIG. 2, in box 16, three units of the digital currency 12 (C57123, C57124, C57125) has an associated user unique number (e.g., O=40007754), which had previously been assigned to the citizen 14 when the citizen 14 successfully enrolled in the OCD digital currency system, thus indicating that the three units of the digital currency 12 currently belong to the citizen 14. The three units of the digital currency 12 also have an assigned category of use (C), i.e., a Medical category of use.

As part of the transaction 10, the citizen 14 purchases medicine 18 from a pharmacist (merchant) 22, e.g., using two of the three units of the digital currency 12 (e.g., units C57123 and C57124). In exchange for the purchase of the medicine 18 from the pharmacist 22 by the citizen 14, the OCD digital currency system 30 changes the user unique number associated with these two digital currency units from the user unique number of the citizen 14 (O=40007754) to the user unique number of the pharmacist 22 (O=B229E696), as shown in box 24, indicating that ownership (O) of the two digital currency units has been transferred from the citizen 14 to the pharmacist 22. According to an embodiment, the OCD digital currency system 30 has an ownership component or processing unit 32, which changes the ownership of the digital currency units associated with the transaction, as appropriate.

Also, the OCD digital currency system 30 changes the category of use (C) of the digital currency units from Medical to General, as shown in box 24, based on the nature of the transaction 10. According to an embodiment, the OCD digital currency system 30 has a category of use component or processing unit 34, which changes the category of use the digital currency units associated with the transaction, as appropriate.

Once the category of use of the digital currency units has been changed from Medical to General, the digital currency units (now belonging to the pharmacist 22) have little or no restrictions on them compared to when the digital currency units were assigned a Medical category of use, assuming the General category of use has a set of use restrictions that has relatively little or no restrictions compared to the set of use restrictions for the Medical category of use. Therefore, the pharmacist 22 can use the newly owned digital currency units for any purpose, unlike the citizen 14, who could only use the digital currency units, when owned, for medical purposes.

As discussed hereinabove, according to an embodiment, the COO digital currency system 30 also has a currency unique number component or processing unit 36, which assigns a currency unique number to each denominated unit of digital currency when the administrator of the OCD digital currency system releases the digital currency units into the digital currency system. The OCD digital currency system 30 also has a user unique number component or processing unit 38, which assigns a user unique number to each user that successfully enrolls or registers with the OCD digital currency system.

According to an embodiment, the OCD digital currency system keeps track of and maintains the ownership (O) and category of use (C) of each denominated unit of digital currency (D) within the OCD digital currency system, e.g., using block chain technology and/or other suitable technology. For example, the digital currency system maintains a database or network of databases that stores the ownership (O) and category of use (C) of each denominated unit of digital currency (D) within the OCD digital currency system, and updates the ownership (O) and category of use (C) of each denominated unit of digital currency (D) within the OCD digital currency system upon the completion of each digital currency transaction.

Also, according to an embodiment, each user registered or enrolled in the OCD digital currency system has a stored value account or other suitable account associated with the assigned user unique number of the user. The OCD digital currency system keeps track of and maintains in the stored value account of the user the denominated units of digital currency belonging to the user. The digital currency system also updates the stored value account of the user upon the completion of each digital currency transaction involving the user.

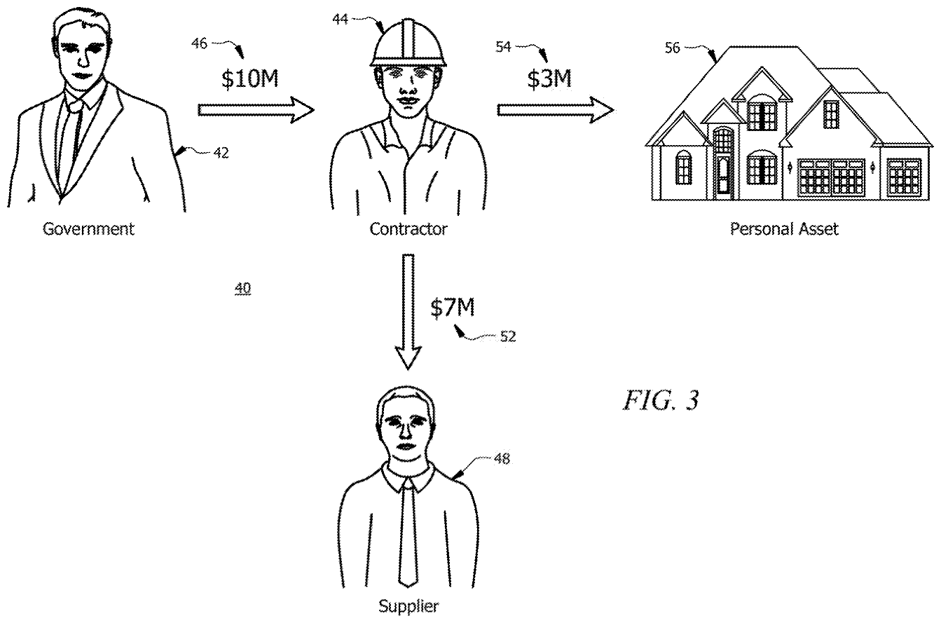

FIG. 3 is a schematic view of a conventional currency road development project transaction 40 involving a government contractor. Before the transaction 40 occurs, the government 42 chooses a contractor 44 to perform the road development project, and allocates 10 million dollars 46 to pay for the road development project. Because the transaction 40 is a conventional currency transaction, the allocated 10 million dollars 46 is in the form of physical currency or other means of conventional currency.

Assume that the contractor 44 needs 7 million dollars of material to perform the road development project. Therefore, as part of the transaction 40, the contractor 44 buys material from a supplier 48 using 7 million dollars 52 of the 10 million dollars 46 allocated to the contractor 44. Upon completion of the road development project, the contractor 44 uses the remaining 3 million dollars 54 of the 10 million dollars 46 allocated to the contractor 44 to purchase some personal assets 56. The purchase of personal assets 56 by the contractor 44 is improper, because all of the 10 million dollars allocated to the contractor 44 was supposed to be used for the road development project.

Because the road development project transaction 40 is conducted using a conventional currency system, the 10 million dollars 46, once allocated to the contractor 44, goes undetected by the conventional currency system. For example, a conventional currency system does not keep track of the 7 million dollar 52 purchase of material by the contractor 44 form the supplier 48, or the subsequent 3 million dollar 54 purchase of personal assets 56 by the contractor 44 upon completion of the road development project. Therefore, because the 3 million dollars 54 used by the contractor 44 to purchase personal assets 56 should have been used as part of the road development project, a conventional currency system has no way of knowing that a potential fraudulent activity has occurred.

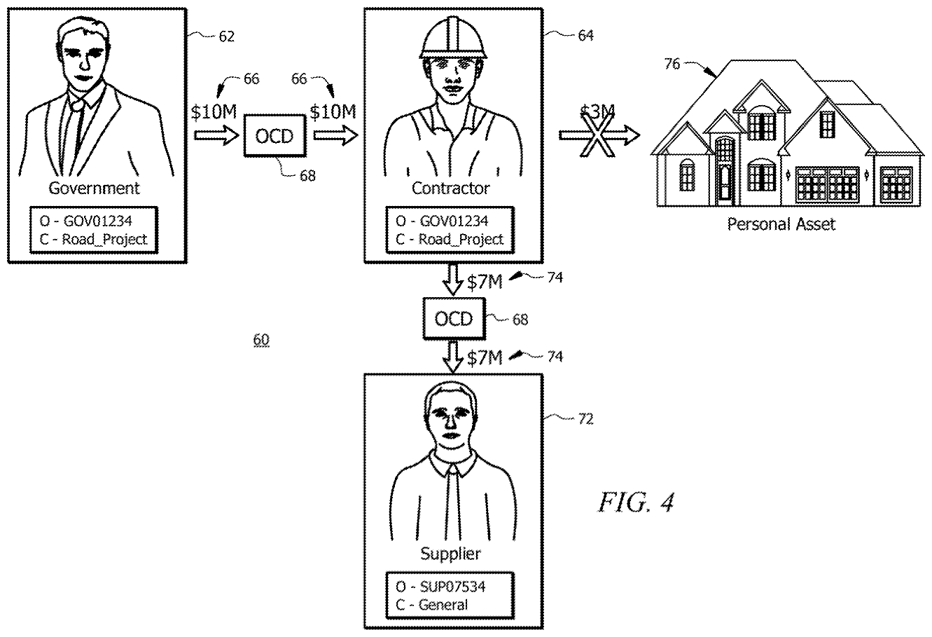

FIG. 4 is a schematic view of the road project transaction 60 of FIG. 3, using ownership and classification of digital currency (OCD), according to an embodiment. Before the transaction 60 occurs, the government 62 chooses a contractor 64 to perform the road development project, and allocates 10 million dollars 66 to pay for the road development project.

Initially, ownership (O) of the 10 million dollars 66 belongs to the government 62 (O—GOV01234), and the classification (C) of the 10 million dollars 66 is assigned to a Road_Project category of use (C—Road_Project). As discussed hereinabove, according to an embodiment, the OCD digital currency system 68 maintains and keeps track of all changes in ownership (O) and classification (C) of digital currency (D) during all phases of any transaction involving digital currency units within the OCD digital currency system.

Once the 10 million dollars 66 is allocated by the government 62 to the contractor 64 for the road development project, the OCD digital currency system 68 changes the ownership (O) of the 10 million dollars 66 from the government 62 to the contractor 64. For example, the user unique number associated with the digital currency units that constitute the allocated 10 million dollars 66 (which have their own currency unique number, as discussed hereinabove) is changed from the user unique number of the government 62 (O—GOV01234) to the user unique number of the contractor 64 (O—CON05678). However, the classification (C) of the 10 million dollars 66 remains assigned to the Road_Project category of use (O—Road_Project).

Assume that the contractor 64 needs 7 million dollars of material to perform the road development project. Therefore, as part of the transaction 60, the contractor 64 buys material from a supplier 72 using 7 million dollars 74 of the 10 million dollars 66 allocated to the contractor 64. As a result, the OCD digital currency system 68 changes the ownership (O) of the 7 million dollars 74 from the contractor 64 to the supplier 72. For example, the user unique number associated with the digital currency units that constitute the 7 million dollars 74 is changed from the user unique number of the contractor 64 (O—CON05678) to the user unique number of the supplier 72 (O—SUP07534). Also, the OCD digital currency system 68 changes the classification (C) of the 7 million dollars 74 from the Road_Project category of use to a General category of use, as this is a typical business transaction for the supplier 72. According to an embodiment, the OCD digital currency system 68 maintains and keeps track of the changes in ownership (O) and classification (C) of the digital currency (D) during this phase of the transaction 60.

Upon completion of the road development project, the contractor 64 still has 3 million dollars remaining from the initial allocation of 10 million dollars 66. However, within the OCD digital currency system 68, the classification of this 3 million dollars is still assigned to the Road_Project category of use within the OCD digital currency system 68. Therefore, if the contractor 64 attempts to purchase personal assets 76 with the 3 million dollars, the OCD digital currency system 68 will identify the attempted purchase of personal assets as improper, based on the current classification of the 3 million dollars (Road_Project category of use). According to the OCD digital currency system 68, digital currency units assigned to the Road_Project category of use are allowed to be used only for the road development project, and are not allowed to be used for the purchase of personal assets. According to an embodiment, the OCD digital currency system 68 notifies the appropriate parties involved in the attempted purchase of personal assets by the contractor 64, and all such attempted transactions will be terminated without completion. In this manner, the OCD digital currency system 68 prevents illegal activities involving digital currency units within the OCD digital currency system.

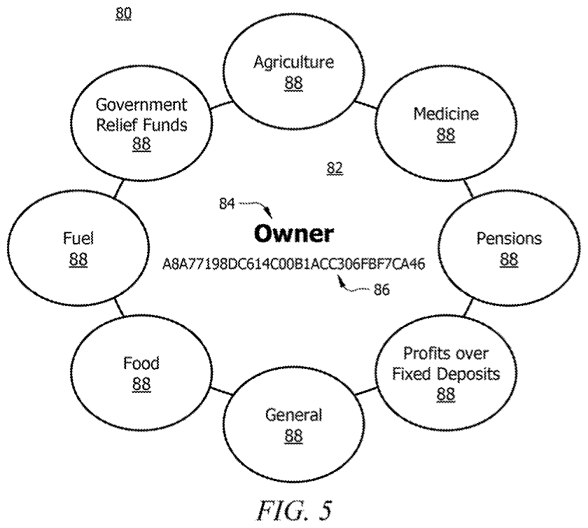

FIG. 5 is a schematic view 80 of a unit of digital currency 82, including the owner and possible category of use to which the digital currency unit 82 belongs, according to an embodiment. According to an embodiment, the digital currency unit 82 includes an owner 84, as represented by a user unique number 86, as discussed hereinabove. The digital currency unit 82 also belongs to one or more categories of use 88. As discussed hereinabove, each category of use 88 has a defined set of rules for the use of the digital currency unit 82 assigned to that category of use 88. However, as discussed hereinabove, the category of use to which the digital currency unit 82 belongs can change as the result of a digital currency transaction involving the digital currency unit 82. For example, if the digital currency unit 82 is presently assigned to the General category of use, the digital currency unit 82 can be used any way desired by the owner 84 of the digital currency unit 82, However, if the digital currency unit 82 is presently assigned to the Fuel category of use, the digital currency unit 82 can be used only according to the defined set of rules for the Fuel category of use, e.g., in transactions involving the purchase of fuel.

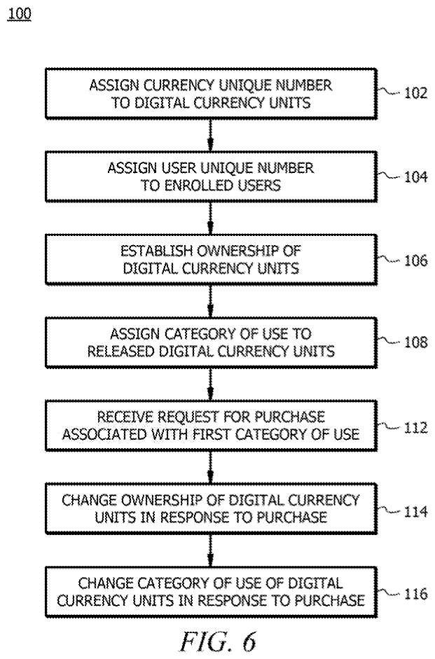

FIG. 6 is a flow diagram of a method 100 for ownership (O) and classification (C) of digital currency (D), according to an embodiment. The method 100 includes a step 102 of establishing or assigning identification to digital currency issued by the OCD digital currency system. For example, as discussed hereinabove, the OCD digital currency system includes a currency unique component that assigns a currency unique number to each denominated unit of digital currency issued by the OCD digital currency system.

The method 100 also includes a step 104 of establishing or assigning identification to each user who has successfully enrolled in or registered with the OCD digital currency system. For example, as discussed hereinabove, the OCD digital currency system includes a user unique number component that assigns a user unique number to each user enrolled in or registered with the OCD digital currency system.

The method 100 also includes a step 106 of establishing ownership of digital currency issued by the OCD digital currency system. As discussed hereinabove, the OCD digital currency system includes an ownership component that establishes ownership of each denominated unit of digital currency issued by the OCD digital currency system. For example, the OCD digital currency system establishes ownership of digital currency units by associating the user unique number of a user with the currency unique number of each digital currency unit that is sanctioned or allocated to that particular user.

The method 100 also includes a step 108 of assigning a category of use to digital currency issued by the OCD digital currency system. For example, as discussed hereinabove, the OCD digital currency system includes a category or use component that assigns a category of use to each denominated unit of digital currency that is released by the OCD digital currency system and sanctioned or allocated to a particular user.

The method 100 also includes a step 112 of receiving a request for a purchase associated with a category of use. As discussed hereinabove, as part of a transaction within the OCD digital currency system, a user issues a request to the OCD digital currency system for a purchase associated with a category of use. For example, a user issues a request for the purchase of medicine, from a pharmacist, with digital currency units owned by the user and having a currently assigned Medicine category of use.

The method 100 also includes a step 114 of changing the ownership of digital currency units involved in a transaction within the OCD digital currency system. For example, in response to the purchase of medicine by a user from a pharmacist, the OCD digital currency system (via its ownership component) changes the ownership of the digital currency units involved in the purchase from that of the user to that of the pharmacist.

The method 100 also includes a step 116 of changing the category of use of digital currency units involved in a transaction within the OCD digital currency system. For example, in response to the purchase of medicine by a user from a pharmacist, the OCD digital currency system (via its category of use component) changes the category of use of the digital currency units involved in the purchase from the Medicine category of use to the General category of use.

It should be understood that the OCD digital currency system described herein can be implemented with or integrated into a conventional block chain system. According to an embodiment, the OCD digital currency system can include one or more databases or other suitable means for implementing with a conventional block chain system. Smart contracts, which are self-executing contracts contained within a conventional block chain system that provide contract validation, can provide transaction validation, category matching, authentication and authorization within the OCD digital currency system. Also, instructions written for contract validation within a conventional block chain system can provide the change of ownership and change of category of use for successful transactions occurring within the OCD digital currency system.

It will be apparent to those skilled in the art that many changes and substitutions can be made to the embodiments described herein without departing from the spirit and scope of the disclosure as defined by the appended claims and their full scope of equivalents.

1. A method for ownership and classification of digital currency units, the method comprising:
establishing identification to at least one unit of digital currency within a digital currency system;
establishing identification to at least one user enrolled in the digital currency system;
establishing ownership of the at least one unit of digital currency to the at least one user;
assigning at least one first category of use to the at least one unit of digital currency owned by the at least one user;
receiving from the at least one user a request for a purchase associated with the at least one first category of use from a merchant enrolled in the digital currency system using the at least one unit of the digital currency owned by the at least one user;
in response to the purchase, changing the ownership of the at least one unit of the digital currency used in the purchase from the at least one user to the merchant; and
in response to the purchase, changing the at least one first category of use of the at least one unit of digital currency used in the purchase to at least one second category of use,
wherein changing the ownership of the at least one unit of the digital currency used in the purchase indicates that the at least one unit of the digital currency used in the purchase now belongs to the merchant, and
wherein changing the at least one first category of use of the at least one unit of digital currency used in the purchase to the at least one second category of use allows the merchant to use the at least one unit of the digital currency used in the purchase according to a second set of rules defining the use digital currency assigned to the at least one second category of use.

2. The method as recited in claim 1, wherein establishing identification to the at least one unit of digital currency further comprises assigning a currency unique number to the at least one unit of digital currency.

3. The method as recited in claim 2, wherein establishing identification to the at least one user further comprises assigning a user unique number to the at least one user.

4. The method as recited in claim 3, wherein establishing ownership of the at least one unit of digital currency to the at least one user further comprises associating the assigned currency unique number of the at least one unit of digital currency with the user unique number of the at least one user.

5. The method as recited in claim 3, wherein the merchant has a user unique number different than the user unique number of the at least one user, and wherein changing the ownership of the at least one unit of the digital currency used in the purchase from the at least one user to the merchant further comprises associating the currency unique number of the at least one unit of digital currency used in the purchase with the user unique number of the merchant.

6. The method as recited in claim 1, wherein the at least one first category of use includes a set of rules defining the use of digital currency assigned to the at least one first category of use.

7. A digital currency system, the system comprising:
a currency unique number component for establishing identification to at least one unit of digital currency within a digital currency system;
a user unique number component for establishing identification to at least one user enrolled in the digital currency system;
an ownership component for establishing ownership of the at least one unit of digital currency to the at least one user;
a category of use component for assigning at least one first category of use to the at least one unit of digital currency owned by the at least one user,
wherein the ownership component, in response to a purchase associated with the at least one first category of use from a merchant enrolled in the digital currency system using the at least one unit of the digital currency owned by the at least one user, changes the ownership of the at least one unit of the digital currency used in the purchase from the at least one user to the merchant,
wherein the category of use component, in response to the purchase associated with the at least one category of use from the merchant using the at least one unit of the digital currency owned by the at least one user, changes the at least one first category of use of the at least one unit of digital currency used in the purchase to at least one second category of use,
wherein changing the ownership of the at least one unit of the digital currency used in the purchase indicates that the at least one unit of the digital currency used in the purchase now belongs to the merchant, and
wherein changing the at least one first category of use of the at least one unit of digital currency used in the purchase to the at least one second category of use allows the merchant to use the at least one unit of the digital currency used in the purchase according to a second set of rules defining the use digital currency assigned to the at least one second category of use.

8. The system as recited in claim 7, wherein the currency unique number component establishes identification to the at least one unit of digital currency by assigning a currency unique number to the at least one unit of digital currency.

9. The system as recited in claim 8, wherein the user unique number component establishes identification to the at least one user by assigning a user unique number to the at least one user.

10. The system as recited in claim 9, wherein the ownership component establishes ownership of the at least one unit of digital currency to the at least one user by associating the assigned currency unique number of the at least one unit of digital currency with the user unique number of the at least one user.

11. The system as recited in claim 10, wherein the merchant has a user unique number different than the user unique number of the at least one user, and wherein the ownership component changes the ownership of the at least one unit of the digital currency used in the purchase from the at least one user to the merchant by associating the currency unique number of the at least one unit of digital currency used in the purchase with the user unique number of the merchant.

12. The system as recited in claim 7, wherein the at least one first category of use includes a set of rules defining the use of digital currency assigned to the at least one first category of use.
